(19) United States
(12) Patent Application Publication
(10) Pub. No.: US 2008/0293009 A1
(43) Pub. Date: Nov. 27, 2008

(54) Ultrasonic dental cleaner

(76) Inventor: Ronald H. Winston, New York, NY (US)

Correspondence Address: Edwards Angell Palmer & Dodge LLP, P.O. Box 55874, Boston, MA, 02205, US

(21) Appl. No.: 12/149,971

(22) Filed: May 12, 2008

Related U.S. Application Data
(60) Provisional application No. 60/928,599, filed on May 10, 2007.

(51) Int. Cl. A61C 17/00

(52) U.S. Cl. 433/119

(57) ABSTRACT

An ultrasonic dental cleaning device for ultrasonically removing deposits from the surface of teeth using a low voltage design. The device having a handle with an ultrasonic driving system for transmitting ultrasonic energy containing a mixed iron oxide rod, a coil around the mixed iron oxide rod, a processor connected to the coil configured and adapted to output ultrasonic electrical energy, and at least two leads connected to a magnet on either end of the rod and coil. A cleaning tip is operably coupled to the handle and configured to be driven to oscillate by the ultrasonic driving system. A power supply configured and adapted to provide electric power to the ultrasonic driving system with a cord.

### PRIORITY

This application claims priority to U.S. Provisional Application No. 60/928,599 filed May 10, 2007.

### FIELD OF INVENTION

This invention relates generally to a device for maintaining dental hygiene. More specifically, this invention relates to a device for ultrasonically removing deposits from the surface of teeth.

### BACKGROUND OF THE INVENTION

Traditional ultrasonic systems comprise a transducer, generator, horn, etc. A typical transducer configuration consists of a piezo-ceramic material that physically changes dimension along the longitudinal axis when excited by an electrical pulse. The speed of sound, mass, and dimension along the longitudinal axis of the transducer determines its resonant length, which determines the overall optimal operating frequency of the tool. The ultrasonic generator transforms the electrical power from a power source into a high frequency signal which energizes the transducer. When the transducer is excited ultrasonic vibration waves are transmitted to the tool, which can perform various types of work.

Typical tool systems use electrostrictive (crystal) transducers that are pulsed by an alternating electrical current. The transducer can be made from a crystal bonded or compressed by bolts to the bottom of a horn. Improvements to crystal transducers include assembling the transducer into a series of stacks. In an electrostrictive transducer, the alternating electrical field causes the transducer to expand and contract.

Alternatively, magnetostrictive transducers, which are pulsed by an alternating magnetic field, can be used. In a magnetostrictive transducer, a stack of thin shim stock, usually made from nickel, is brazed together and surrounded by a magnetic coil. By alternating the polarity of the current passing through the coil, the polarity of the magnetic field is alternated, which causes the shim stock to expand and contract. Magnetostrictive transducers have a greater temperature-resistance than electrostrictive transducers. However, eddy currents cause heating, therefore these transducers generally require air or liquid cooling in order to function at high power.

The use of ultrasonic dental cleaners to remove deposits from the surface of a person's tooth has increased over the years. Traditionally, it was only dentists or specially trained operators who were able to use a device which used ultrasonic energy to drive a metal scaling device in order to scrape away any deposits such as stains, tartar, and plaque. However, the metal tip used on conventional devices readily becomes hot, particularly in contact with the teeth and gums, and requires substantial temperature control in the form of water cooling. In addition, if the device is mishandled, the metal tip can easily damage a tooth's surface or the gums of the patient. In order for more than one person to use the cleaning equipment, proper sterilization or multiple tips must be employed, which can be expensive.

More recently, devices which are more suitable for home or personal use have been developed which allow a user to maintain a daily regimen of removing dental plaque to maintain dental hygiene. Previous dental cleaners which were suitable for home or personal use were based on a magnetostrictive stack system or a high-voltage crystal resonator, as discussed above. Other ultrasonic tooth cleaners utilize an ultrasonic driver such as a magnetic coil system, a fluid pressure, or an air/piston system to drive the cleaning device.

U.S. Pat. No. 3,547,110 to Balamuth discloses using an ultrasonically vibrated nozzle having a continuous or pulsed stream of liquid passing though to clean a user's teeth. The ultrasonic vibrations of the water provide a sufficient micro-fatiguing action to remove the weakly-bonded deposits via the liquid stream. The velocity of the liquid jet stream is controlled by a pump which supplies the liquid from a reservoir, creating a low frequency energy pulse. The low frequency energy pulse drives the liquid jet stream. A generator converts the current from the power supply to an ultrasonic frequency in the range of 16,000 to 40,000 Hertz (Hz) and energizes an ultrasonic motor which is housed inside the cleaning device. The ultrasonic energy is then transmitted to the liquid stream to create a micro-pulsating cleaning action.

In Balamuth, the cleaning device is positioned within the user's mouth and the liquid jet stream is directed at the user's teeth. The liquid jet stream can be combined with a grit, such as toothpaste, for improved removal of tartar and other hard deposits via a brush. The brush includes a magnetostrictive stack, which is driven by a magnetic field, to achieve a mechanical vibration.

U.S. Pat. No. 4,176,454 to Hatter et al. (“Hatter”) discloses a plaque removing device that uses an ultrasonic probe having a plastic head instead of a metal scraper to remove plaque from the tooth's surface. A liquid couplant solution is used as an energy carrier with the ultrasonic probe to transmit sonic energy from the probe to the teeth without requiring any mechanical contact between the probe and the teeth.

In Hatter, the probe is attached to an ultrasonic energy generator located within the handle. A power supply, made from a power oscillator connected to an AC power source, is housed within the handle. The ultrasonic energy generator is made from a resonant ultrasonic transducer which is a single stack formed from a pair of piezoelectric driver discs and a metal shim conductor that is positioned between the driver discs. The generator is attached to the power supply via a pair of leads. A crystal sensor feedback pick-up provides a signal feedback which is transmitted to the power oscillator to control the output frequency of the generator.

In Hatter, an ultrasonic coupling rod is placed within the ultrasonic probe and is attached to the ultrasonic energy generator. When the probe is inserted into the mouth, the head of the probe, which contains an acoustical reflector, redirects the sonic energy from the rod outwardly towards the inner surface of the teeth and diverts it away from the throat. In addition, the probe is equipped with additional foam insulation, which prevents the sonic energy from being deflected or reflected upwardly towards the roof of the mouth or downwardly towards the tongue and throat.

U.S. Pat. No. 5,772,434 to Winston discloses an ultrasonic tooth cleaner having a piezoelectric ultrasonic driver located in the handle portion. A removable cleaning tip, made from a polymer or filled composite plastic which is resonant at the working frequency, is attached to the handle portion of the cleaning device. The tip also includes a bore through which the cleaning fluid flows. The fluid cools the tip and the contact point with the tooth, and also allows for the cavitation effect, as described above, to clean the tooth's surface.

These traditional devices require substantial power at voltages in the range of 400-500 volts in order to provide the ultrasonic driver with enough power to use the device. These devices were expensive to manufacture and required a great deal of power.

Moreover, there are other examples of known ultrasonic dental tools that are suitable for use by a professional in a dental office, such as the ultrasonic hand-held cleaning device in U.S. Pat. No. 3,956,826 (RE30,536) to Perdreaux and the ultrasonic endodontic dental apparatus of U.S. Pat. No. 4,492,574 to Warrin et al. However, these devices are not well suited for home use.

Therefore, it is desirable to develop an ultrasonic cleaning device which is cheaper to manufacture and requires substantially less power to operate, and is safe even for home use.

### SUMMARY OF THE INVENTION

The present invention relates to an ultrasonic dental cleaning device that utilizes an improved ultrasonic driver made from a ferrite rod excitation system.

In an exemplary embodiment of the present invention, the ultrasonic dental cleaning device can be crafted using commercially available ferrite rods, thus significantly reducing the manufacturing cost of the device.

In an exemplary embodiment of the present invention, the ultrasonic dental cleaning device requires an average of 6-12 volts and a maximum of around 50 volts peak voltage to power the device. As a result, this provides an extra safety measure to the user due to its low-voltage design.

Additionally, in an exemplary embodiment of the present invention, an improved cleaning tip of the ultrasonic dental cleaning device is made from a soft polymer or plastic and can be interchangeable. This allows for a variety of tip sizes and shapes to be used with a single cleaning device.

### BRIEF DESCRIPTION OF THE DRAWINGS

Exemplary embodiments of the present inventions are explained in more detail below with reference to the accompanying drawings, in which:

FIG. 1 is an exploded side view of an ultrasonic dental cleaner according to a first embodiment in accordance with the invention;

FIG. 2 is a side view of the handle of the ultrasonic dental cleaner of FIG. 1, showing the features of the end caps;

FIG. 3 is a side view of the cleaning tip and tip mount of the ultrasonic dental cleaner of FIG. 1;

FIG. 4 is an exploded side view of the ultrasonic driving system of the ultrasonic dental cleaner of FIG. 1, showing the components in detail;

FIG. 5 is a perspective view of an ultrasonic dental cleaner according to a second embodiment in accordance with the invention;

FIG. 6 is a perspective view of the ultrasonic dental cleaner of FIG. 5, showing the handle and end caps removed from the driving system and cleaning tip;

FIG. 7 is a side view of the first end cap of the ultrasonic dental cleaner of FIG. 5, showing where the male threads are located, as well as the internal geometry;

FIG. 8 is a side view of the second end cap of the ultrasonic dental cleaner of FIG. 5, showing where the male threads are located, as well as the internal geometry;

FIG. 9 is a side view of the handle of the ultrasonic dental cleaner of FIG. 5, showing where the female threads are located, as well as the internal geometry;

FIG. 10 is a side view of the cleaning tip of the ultrasonic dental cleaner of FIG. 5, showing the shape of the bends in the tip, as well as the female threads;

FIG. 11 is a side view of the tip mount of the ultrasonic dental cleaner of FIG. 5, showing the pin hole, location of the male threads, and the internal geometry;

FIG. 12 is a side view of the sleeve of the ultrasonic dental cleaner of FIG. 5, showing the large and small ends, as well as the internal geometry;

FIG. 13 is a perspective view of the sleeve of the ultrasonic dental cleaner of FIG. 5, showing the sleeve wrapped in wire coils, which are coupled to the electrical cord;

FIG. 14 is a front, side, and top view of the base unit of the ultrasonic cleaner of FIG. 5, showing how the plug housing and switch housing fit together;

FIG. 15 is a front, side, and top view of the switch housing of the ultrasonic cleaner of FIG. 5, showing the internal geometry;

FIG. 16 is a front, side, and top view of the plug housing of the ultrasonic cleaner of FIG. 5, showing the internal geometry;

FIG. 17 is a perspective view of the base unit of the ultrasonic dental cleaner of FIG. 5, showing the circuit with transformer in the open housings of the base unit; and

FIG. 18 is a perspective view of the base unit of the ultrasonic dental cleaner of FIG. 5, showing the side of the circuit opposite the transformer.

### DETAILED DESCRIPTION OF THE INVENTION

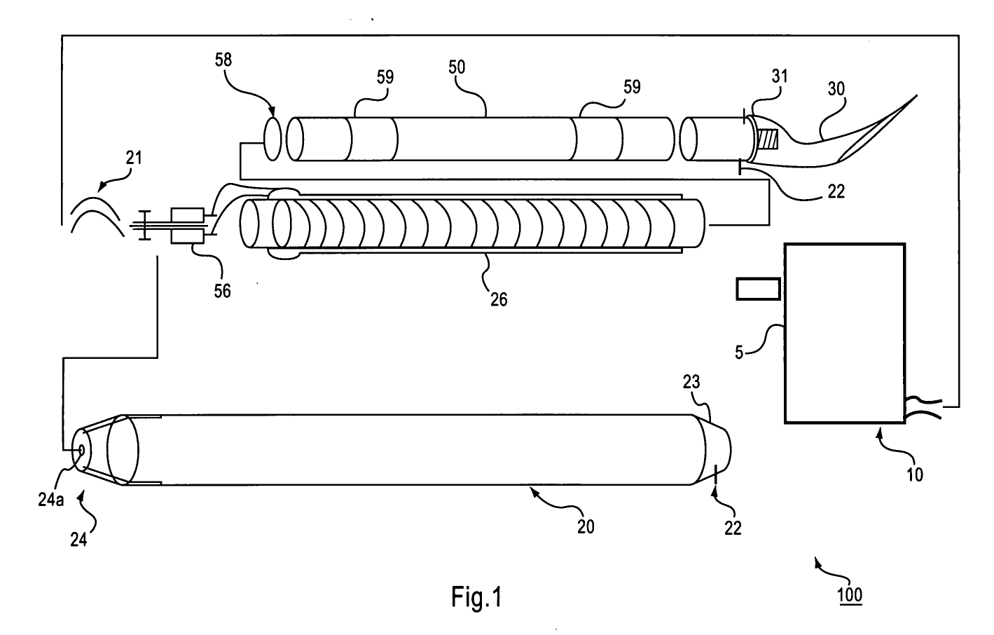

Referring now to the drawings, FIG. 1 illustrates an exploded view of a cleaning system 100 of the present invention. The system 100 comprises a base unit 10, a handle 20, and a cleaning tip 30. The base unit 10 includes a power supply 5 with a standard plug for a wall outlet, which preferably delivers a 6V direct current (DC) from the power supply. However, one of ordinary skill in the art will easily recognize that the power supply 5 can be substituted with a power supply of various voltages. In addition, the power supply can also be delivered as an alternating current (AC) type, without departing from the spirit and scope of the invention. Moreover, those skilled in the art will readily appreciate how to practice the invention with a battery power source and/or an low-voltage AC wall-powered outlet power source. In accordance with the invention, the device can be used with gel peroxides, including foaming frices described below, to aid in foaming, cleansing, cleaning, cooling, bactericidal, and disclosing functions. The gel peroxides can include regular or urea peroxides.

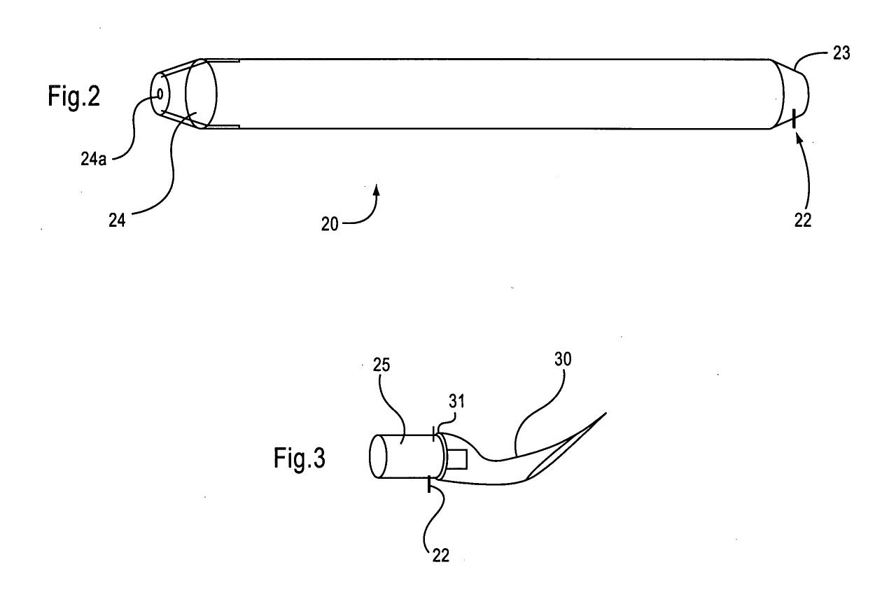

The general structure of the handle 20 will now be described. The handle 20 is attached to the base unit 10 via a cord 21. As illustrated in FIG. 2, the handle 20 is equipped with two caps 23, 24, which are placed on opposing ends of the handle 20. The caps 23, 24 are preferably tapered, but can be flat, circular, or a variety of other shapes as well.

The cap 23, located on the front of the handle 20, includes a pin 22, which is used to secure the tip 30 to the handle 20. The cap 23 is preferably cemented to the handle 20 such that it will not loosen or detach from the handle 20 during operation of the device. The cap 24, located on the back of the handle 20, is affixed to the back of the handle 20 using an epoxy fill or other suitable material. The cap 24 also contains hole 24a that allows for the cord 21 to pass through, as suggested in FIG. 1. It is to be understood that the terms ‘front’ and ‘back’ are merely used as descriptive indicators of relative directions and are in no way limiting to the structure or appearance of the present invention.

Referring now to FIG. 3, a cleaning tip 30 is affixed within cap 23, which is affixed to the handle 20 as described above. The tip 30 is preferably a removable tip, which can be screwed or mounted into the tip mount 25. Tip mount 25 is attached to rod 50 and or sleeve 52, as will be described below. A pin 22 in tip mount 25 is used in conjunction with cap 23 to secure and release tip 30 from tip mount 25. Pin 22 can be spring loaded or broached threaded or any of a number of quick-disconnect configurations as are known in the art. Pin 22 also extends through a hole in cap 23 when system 100 is assembled, as shown in FIG. 2. One end 31 of tip 30 connects with the tip mount 25 to secure the tip 30. End 31 is preferably flush with tip mount 25 and can contain a female threading so as to allow a male thread end protruding from tip mount 25 to be secured. Alternatively, end 31 can be secured to tip mount 25 via other securement means, such as a pin and lock mechanism.

In addition, the tip 30 is preferably made from a relatively hard plastic, flexible polymer composite, such as a graphite filled polymer, or reinforced carbon. The material from which the tip 30 is made from must be able to withstand the high stress and energy produced with constant ultrasonic vibration without overheating. In addition, the material should preferably have a hardness that is much less than that of tooth enamel so as to not damage the tooth when the tip 30 comes into contact with it. A softer tip according to the invention is also preferable in that it can operate with less need for cooling compared to the metal tips in the art. In addition, the material must be capable of transmitting ultrasonic energy in the desired frequency and amplitude ranges.

The tip 30 is also preferably constructed such that it can be mass-produced, thereby reducing the overall cost of the device. In addition, since the tip 30 is detachable from the cap 23, this allows multiple users to utilize a single cleaning system 100, making the device more cost-effective. The tip 30 can take on a variety of shapes and sizes. Ideally, the tip has multiple bends or a curved shape to allow the device operator to reach any surface within the oral cavity. For example, the tip 30 can have an elongated curved shape, as illustrated in FIG. 3.

On the other end of the tip 30 it is possible to have an opening connected to a fluid reservoir as is known in the art for delivering a fluid to the tip. However, it is also possible with the invention to eliminate the need for a fluid reservoir altogether. If the system 100 does not comprise a fluid chamber and an internal fluid system, then the tip 30 is to be placed within the user's mouth along with an external fluid such as water or one of a number of bacteriostatic, bactericidal, anti-metabolic, or cell lysis compounds. (See, for example, the compositions disclosed in U.S. Pat. No. 6,306,370 to Jensen, et al., as well as U.S. Pat. No. 3,657,413 to Rosenthal). Use of foamed cleaning adjuncts, or foam frices, can assist in bacteria killing, provide cooling, and eliminate the need for water irrigation. Some frices known in the art can be applied to dental surfaces, whereupon the frices foam where they come into contact with dental plaque. Thus the frices serve to identify or disclose where the tip of a plaque remover needs to be applied. At the same time, the frices can serve as a lubricant and coolant for the tip as it works along the dental surface, eliminating the need for fluids delivered through the tool. Those skilled in the art will readily appreciate that if such frices are used, opening 32 can be eliminated. When the system 100 is activated, the ultrasonic waves generated by the system 100 (described below) will be transmitted from the tip 30 into the external fluid located within the user's mouth. The cavitation effect is then induced into the external fluid to clean the user's teeth.

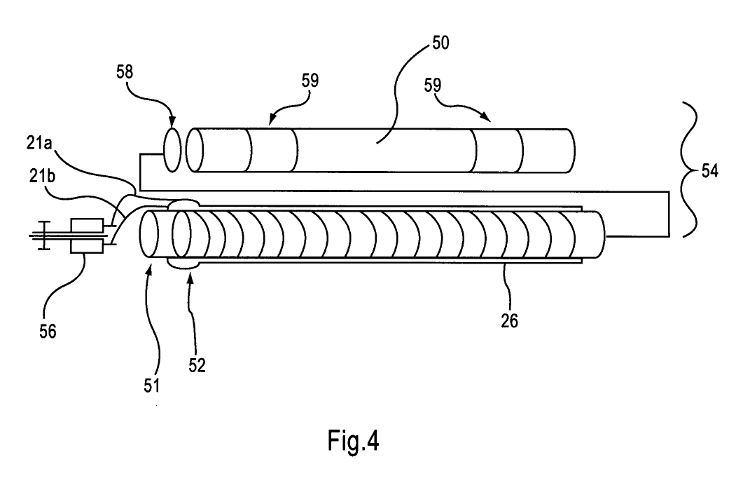

With reference now to FIG. 4, the ultrasonic driving system 54 of the cleaning device 100 will now be described. FIG. 4 illustrates a rod 50 according to one embodiment of the present invention. The rod 50 is normally housed within sleeve 26, which is in turn positioned within the handle 20, as indicated in the exploded view of FIGS. 1 and 4. The rod 50 is preferably a mixed iron oxide rod, such as a ferrite rod that is commercially available, either in bulk units or for single sale. The rod can also be made from a pressed or sintered oxide. As an example, several vendors such as DigiKey or Surplus Sales of Nebraska sell a variety of ferrite rods ranging from 2 inches in length to 8 inches in length. However, those skilled in the art will recognize that rod 50 can be made from any material that exhibits magnetostrictive properties, such as nickel can be made in a variety of shapes such as a tube.

The exact length of the rod 50 will be dependent based on the resonant frequency desired. Ideally, the operating range of vibrating frequencies for the cleaning system 100 is between 20,000 Hz and 50,000 Hz. It is also possible to practice the invention in the range of 20,000-40,000 Hz.

A processor 56, powered by power supply 5 via cord 21, delivers an ultrasonic electrical signal to leads 21a and 21b, which in turn connect to magnet 51 and/or coil 55 to induce oscillations in the magnetic field. Such processors typically include an oscillator and a push-pull amplifying circuit and are commercially available, such as the Battery Operated 25 kHz Ultrasonic Processor Model 4180, manufactured by Sonaer Ultrasonics, at 145 Rome Street, Farmingdale, N.Y. 11735. The oscillations in the magnetic field surrounding rod 50 cause rod 50 to vibrate at the ultrasonic frequency.

The rod 50 is placed within the handle 20 and is equipped with a magnet 51 on one end of the rod 50. O-rings or Teflon tape 59 around rod 50 assure that rod 50 connects at its nodal points to sleeve 26 to reduce damping and facilitate the proper motion when system 100 is in operation. O-rings 59 also provide for an air gap between rod 50 and sleeve 26. The magnet 51 is affixed securely to the rod 50 by means of an epoxy 52, or another similarly suitable adhesive. A Mylar disk 58 is included, as depicted in FIG. 1, to facilitate good fit and operation. Leads 21a, 21b extend from the cord 21 and attach to the magnet 51 in order to drive the magnet 51/coil 55. When power from the power supply 5 is supplied to the magnet 51/coil 55 through processor 56, the magnet 51/coil 55 induces a magnetic field that oscillates at an ultrasonic frequency and thus causes the rod 50 to exhibit its magnetostrictive properties predominantly in the longitudinal direction. The rod 50 will change dimension along the longitudinal axis by expanding and contracting at ultrasonic frequencies when subjected to the magnetic field. When the rod 50 is excited by the magnetic field, there is a longitudinal translation of approximately 20-75 microns in length. By converting the magnetic energy to mechanical energy in this manner, ultrasonic waves can be transferred to the tip 30, through tip mount 25 attached to rod 50 and/or sleeve 26.

FIG. 4 shows a wire 55 wrapped around the sleeve 26. Thus when rod 50 is housed in sleeve 26, the coils of wire 55 surround rod 50. In this particular embodiment, the power supply 5 is an AC power supply. Lead 21a is connected to one end of the wire 55, while lead 21b is connected to the other end of the wire 55. Electrical power in the form of an ultrasonic signal from processor 56 is converted into an alternating magnetic field through the use of the coil of wire 55. The alternating magnetic field is then used to induce mechanical vibrations at the ultrasonic frequency in the rod 50. The frequency of the AC electrical energy applied to the transducer is the same as that of the mechanical vibration frequency. Therefore, by inducing a magnetic field via the wire 55, the rod 50 will exhibit its magnetostrictive properties and expand and contract accordingly.

While the embodiment shown in FIGS. 1-4 is shown incorporating both magnet 51 and wire coils 55 to induce ultrasonic vibrations in rod 50, those skilled in the art will readily appreciate how to practice the invention with only one of the magnets 51 and coils 55 without departing from the spirit and scope of the invention.

The overall power consumption of the cleaning device 100 is substantially lower than that of the traditional models. For example, the present invention is capable of utilizing only 1 to 2 watts of input power in the form of electrical energy, with an output power of approximately 0.1 watts in the form of mechanical energy. This overall lower power requirement is due particularly to the lower requirements for exciting of ferrite compared to piezo-electric ceramics as in the art.

Those skilled in the art will appreciate how to modify the cleaning device 100 of the present invention to include a fluid chamber, for example in a base unit. The fluid chamber can be filled with a fluid such as water or one of a number of bacteriostatic, bactericidal, anti-metabolic, or cell lysis compounds suitable for use with dental cleaning. The fluid can flow from the chamber through a passageway, which is provided as a separate tubing within the cord to an opening in the tip, as is known in the art. Within the handle, the fluid can surround the rod such that when the rod is subjected to the magnetic fields, ultrasonic waves are induced in the fluid, which are then outputted via the opening in the tip. When using the cleaning device which has an internal fluid chamber, there is no need for the user to also provide an external fluid substance. When the fluid is induced with the ultrasonic waves, the same cavitation effect as described in the previous embodiment will occur, thus cleaning the user's teeth.

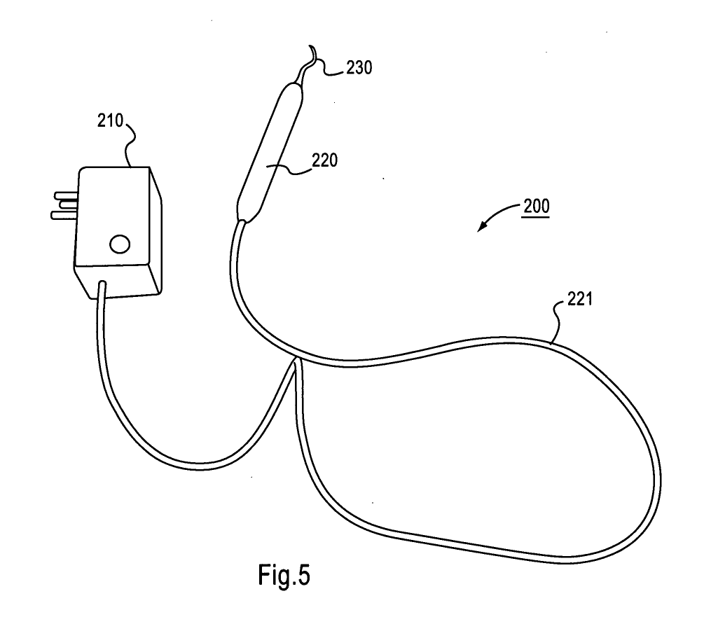

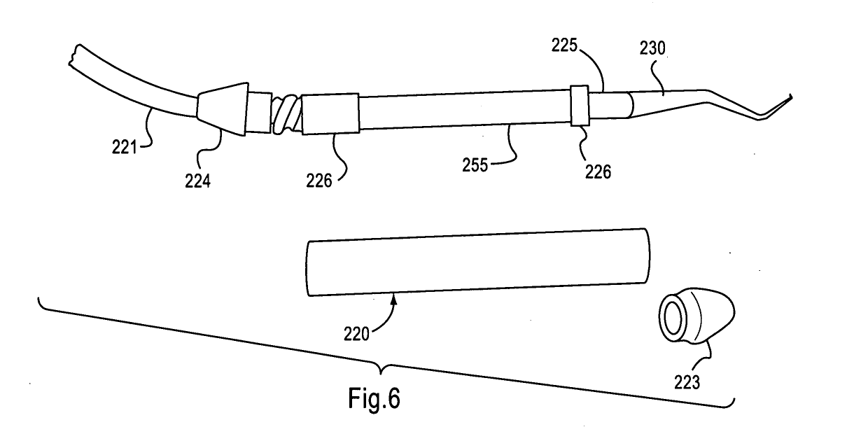

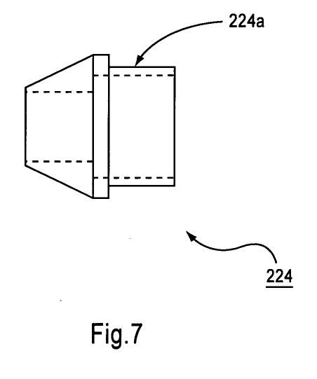

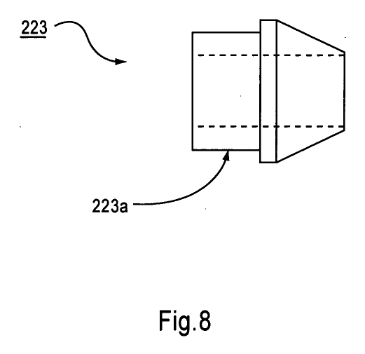

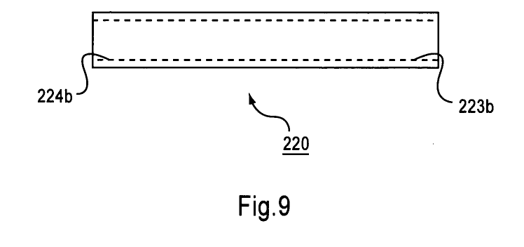

FIGS. 5-18 show an alternative embodiment of the invention. FIG. 5 shows system 200 with power base unit 210. Cord 221 electrically connects base unit 210 to handle 220. Tip 230 extends from the opposite end of handle 220 from cord 221. FIG. 6 shows handle 220 removed from sleeve 226 to reveal wire coils 255 and tip mount 225 attached to sleeve 226. Cap 224 is detached from handle 220, however cord 221 is shown passing through cap 224. Cap 223 is also shown removed from handle 220. Caps 224 and 223 have male threads (224a and 223a, respectively) that engage with female threads in handle 220 (224b and 223b, respectively) when assembled, as indicated in FIGS. 7-9.

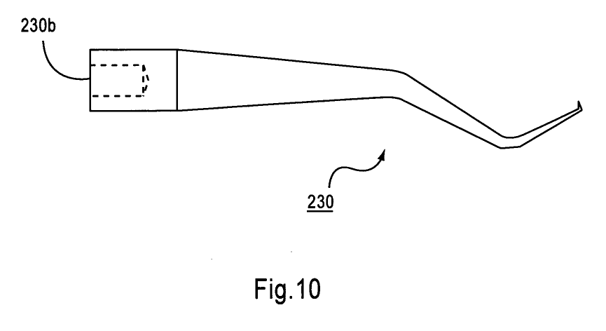

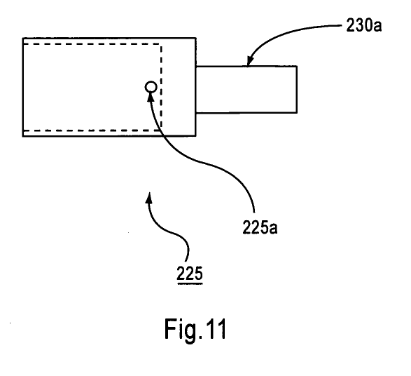

FIG. 10 shows tip 230 with female threads 230b that engage male threads 230a of tip mount 225, as shown in FIG. 11. Tip 230 is bent into a shape which allows tip 230 to reach most dental surfaces within an oral cavity, as is known in the art. Tip 230 is made of a graphite filled polymer material, however those skilled in the art will readily recognize other suitable materials within the scope of the invention, as described above. Tip mount 225 includes a hole 225a suitable for housing a pin (not shown) for securing and releasing tip 230, as described above with respect to tip 30.

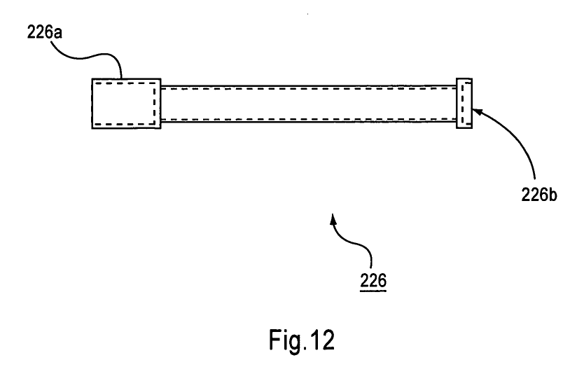

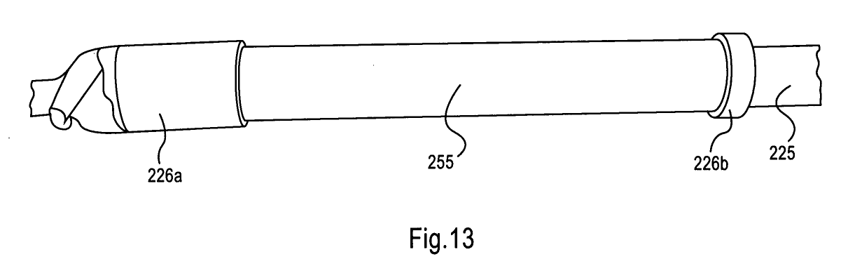

FIG. 12 shows sleeve 226 having a large end 226a and a small end 226b. Large end 226a has an interior for accommodating a magnet (not shown, but see e.g. magnet 51 above) and an exterior for engaging handle 220. Small end 226b engages tip mount 225 end to end, and engages handle 220 when assembled. A ferrite rod (not shown, but see e.g. rod 50 above) fits within the interior passage of sleeve 226, and into the wide opening in the end of tip mount 225. FIG. 13 shows wire coils 255 which are powered with electrical signals at ultrasonic frequencies to induce vibrations in the ferrite rod, as described above with respect to system 100. Also shown in FIG. 13 is epoxy 252 holding components in large end 226a. FIGS. 7-12 show internal features of the respective parts in hidden lines.

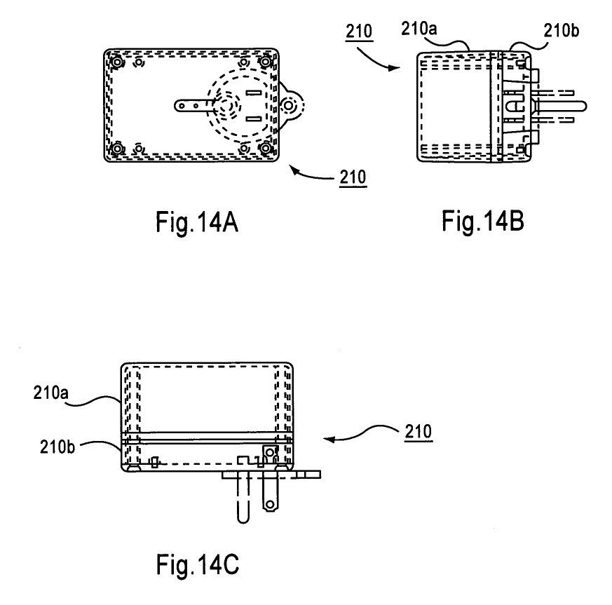

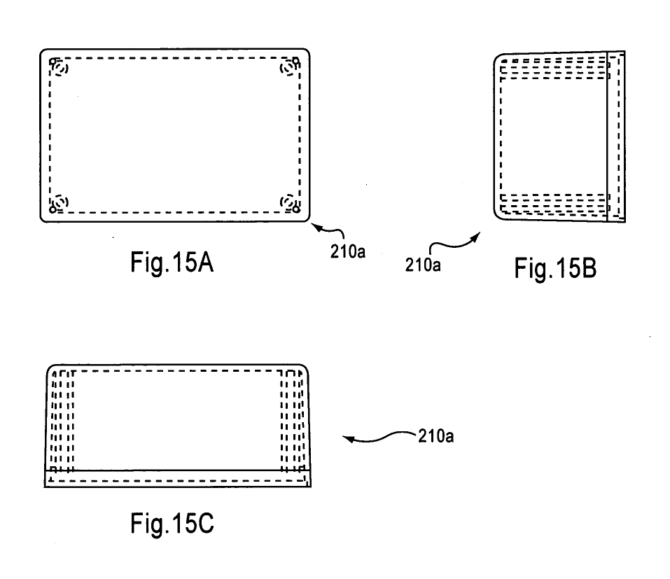

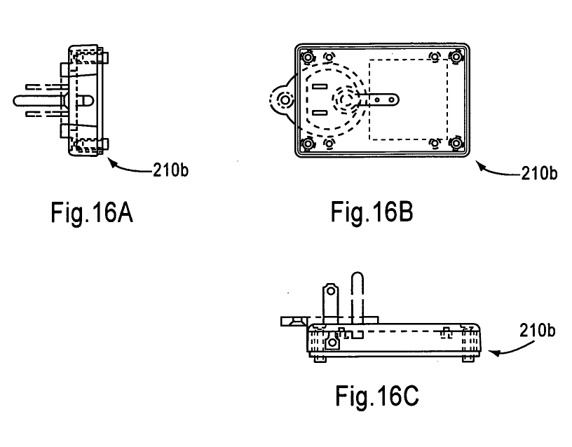

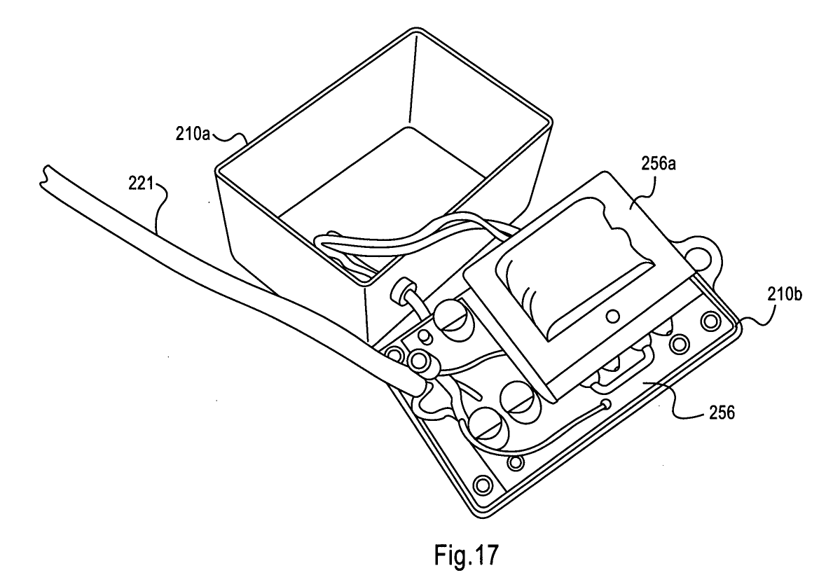

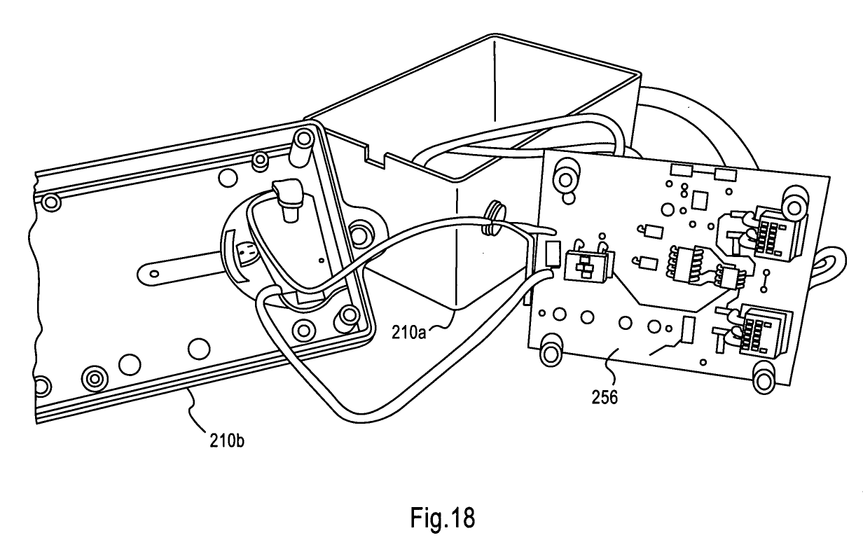

FIG. 14 shows base unit 210 in front, side, and top views. Base unit 210 is made of two halves, the first is switch housing 210a and the second is plug housing 210b, which has a standard three-prong plug for connection with a standard wall outlet. FIG. 15 shows switch housing 210a in three views, and FIG. 16 shows plug housing 210b in three views. Base unit 210 is essentially a shell that houses a circuit 256, which is shown in FIGS. 17 and 18. Circuit 256 includes a transformer 256a, an ultrasonic transducer, and means for converting AC to DC power, as are well known in the art. There is also pictured a switch (connected to yellow wires in switch housing 210a) which allows a user to activate and deactivate system 200 when it is plugged in to a standard wall outlet. Cord 221 connects directly to circuit 256, which connects directly to the switch and the plug.

One benefit of the present invention is that the present invention requires a peak voltage of approximately 50 volts. Previously, traditional cleaning systems which utilized crystal resonators required between 400-500 volts of power for operation. As a result, the cleaning device 100 of the present invention provides an extra safety measure to its users. This extra safety measure makes cleaning devices 100/200 suitable for home use. In addition, because the cleaning device of the present invention is low-powered, it is easier to obtain the necessary approvals from various industry-regulating boards. Moreover, while the invention has been described above having an AC power source with a cord and plug, with such low power requirements, those skilled in the art will readily appreciate how to practice the invention using a battery power source to make a cordless embodiment.

Another benefit of the present invention is that the disposable tips 30 aide in preventing cross-contamination between multiple users of the cleaning device. This allows the device to be utilized by multiple users at a more cost-effective price. The soft material of tips 30 make them safe and suitable for home use.

Furthermore, by using a commercially-available rod 50 and disposable tips 30, the cost of the cleaning device can be substantially reduced. This allows the device to be provided to a consumer for less than the previous technology, further making the system suitable for home use.

While the systems of the present invention, as described above and shown in the drawings, provide for an ultrasonic dental plaque remover with superior properties including operating at low voltages. It will be apparent to those skilled in the art that various modifications and variations can be made in the device of the present invention without departing from the spirit or scope of the invention. Thus, it is intended that the present invention include modifications and variations that are within the scope of the above-described embodiments and their equivalents.

1. An ultrasonic dental cleaning device comprising:
a handle having an ultrasonic driving system for transmitting ultrasonic energy containing a mixed iron oxide rod, a coil around the mixed iron oxide rod, a processor connected to the coil of the handle configured and adapted to output ultrasonic electrical energy, and at least two leads connected to a magnet on either end of the rod and coil;
a cleaning tip operably coupled to the handle and configured to be driven to oscillate by the ultrasonic driving system; and
a power supply configured and adapted to provide electric power to the ultrasonic driving system with a cord.

2. The ultrasonic dental cleaning device of claim 1, wherein the mixed iron oxide rod is a material selected from the group consisting of ferrite, pressed oxide, sintered oxide, and nickel.

3. The ultrasonic dental cleaning device of claim 1, further comprising a base connected to said handle by the cord.

4. The ultrasonic dental cleaning device of claim 1, wherein the ultrasonic driving system is adapted and configured to operate at a voltage less than 50 peak volts.

5. The ultrasonic dental cleaning device of claim 1, wherein the ultrasonic driving system is adapted and configured to operate on an average of 6 to 12 volts.

6. The ultrasonic dental cleaning device of claim 1, wherein the cleaning tip adapted and configured to vibrate at a frequency between 20,000 Hz to 50,000 Hz.

7. The ultrasonic dental cleaning device of claim 1, wherein the cleaning tip is adapted and configured to vibrate at a frequency between 20,000 to 40,000 Hz.

8. The ultrasonic dental cleaning device of claim 1, wherein the ultrasonic driving system is adapted and configured to operate with no more than 2 watts of input power.

9. The ultrasonic dental cleaning device of claim 1, wherein the ultrasonic driving system is adapted and configured to operate with no more than 1 watt of input power.

10. The ultrasonic dental cleaning device of claim 1, wherein the cleaning tip is constructed from the group consisting of relatively hard polymer, plastic, and reinforced carbon.

11. The ultrasonic dental cleaning device of claim 10, wherein the cleaning tip has a hardness that is less than tooth enamel.

12. The ultrasonic dental cleaning device of claim 1, wherein the cleaning tip is interchangeable.

13. The ultrasonic dental cleaning device of claim 1, wherein the cleaning tip is detachably connected to the handle by a screw mechanism to secure and release the tip.

14. The ultrasonic dental cleaning device of claim 1, wherein the cleaning tip is detachably connected to the handle by a tip mount mechanism to secure and release the tip.

15. The ultrasonic dental cleaning device of claim 1, wherein the cleaning tip has multiple bends.

16. The ultrasonic dental cleaning device of claim 1, wherein the cleaning tip has a curved shape.

17. The ultrasonic dental cleaning device of claim 1, further comprising a fluid reservoir in the base of the cleaning tip for delivering a fluid into the cleaning tip.

18. The ultrasonic dental cleaning device of claim 1, wherein a cavitation effect is induced into external fluid to clean teeth.

19. An ultrasonic dental cleaning device comprising:
a handle containing therein an ultrasonic driving system for transmitting ultrasonic energy containing a mixed iron oxide rod, a coil around the mixed iron oxide rod, a processor connected to the coil which outputs ultrasonic electrical energy, and at least two leads connected to a magnet on either end of the rod and coil;
a cleaning tip operably coupled to the handle and configured to be driven to oscillate by the ultrasonic driving system;
a fluid reservoir in the base of the cleaning tip for delivering a fluid; and
a power supply configured to provide electric power to the ultrasonic driving system with a cord,
wherein activation of the device creates ultrasonic waves generated by the device to be transmitted from the cleaning tip into external fluid from the fluid reservoir in the base of the cleaning tip, into the user's mouth.

20. The ultrasonic dental cleaning device of claim 19,
wherein the processor comprises an oscillator and amplifier adapted and configured to output ultrasonic electrical energy.
